(19) United States
(12) Patent Application Publication
(10) Pub. No.: US 2022/0332189 A1
(43) Pub. Date: Oct. 20, 2022

(54) ELECTRONIC DEVICES AND METHODS FOR DISPLAYING INFORMATION ON ELECTRONIC DISPLAYS BASED ON LEARNED USER BEHAVIOR

(71) Applicant: Toyota Research Institute, Inc., Los Altos, CA (US)

(72) Inventors: Kent Lyons, Los Altos, CA (US); Charlene C. Wu, San Francisco, CA (US); Matthew Lee, Mountain View, CA (US); Rumen Iliev, Millbrae, CA (US); Yanxia Zhang, Foster City, CA (US); Yue Weng, San Mateo, CA (US)

(73) Assignee: Toyota Research Institute, Inc., Los Altos, CA (US)

(21) Appl. No.: 17/231,522

(22) Filed: Apr. 15, 2021

(51) Int. Cl. B60K 35/00; G06F 3/14; H04L 29/08

(52) U.S. Cl. CPC B60K 35/00; G06F 3/14; H04L 67/306; G06F 3/04817

(57) ABSTRACT

Electronic devices and methods for displaying information on electronic displays of electronic devices based on learned user behavior are disclosed. In one embodiment, an electronic device includes an electronic display, a processor, and a non-transitory computer-readable medium storing instructions that, when executed by the processor, causes the processor to cause for display on the electronic display a selected representation of information among a plurality of representations based at least in part on learned behavior of a user.

### TECHNICAL FIELD

Embodiments described herein generally relate to electronic displays and, more particularly, to electronic devices and methods for displaying information on electronic displays of electronic devices based on learned user behavior.

### BACKGROUND

Information may be displayed by an electronic display of an electronic device in a variety of different representations. For example, a numerical value may be represented as a numeral, a percentage, a graph, an icon, a color representation, and the like. In a specific example, a state of charge of a battery, such as a battery of a mobile phone, may be represented by a percentage, a graph, an icon (e.g., an icon configured as a battery), a color (e.g., a red battery icon means low charge, a yellow battery icon means a medium charge, and a green battery icon means mostly charged or fully charged), and the like.

Individuals respond differently to representations of information. One individual may inherently prefer to view information as a percentage while another individual may inherently prefer to view the same information as an icon. However, the electronic display may not display a representation of information that is best for a particular user.

Thus, alternative electronic devices and methods for displaying a representation of information on an electronic display of an electronic device may be desired.

### SUMMARY

In one embodiment, an electronic device includes an electronic display, a processor, and a non-transitory computer-readable medium storing instructions that, when executed by the processor, causes the processor to cause for display on the electronic display a selected representation of information among a plurality of representations based at least in part on learned behavior of a user.

In another embodiment, a method includes displaying on an electronic display a representation of information selected among a plurality of representations based on learned behavior of a user.

In yet another embodiment, a vehicle includes an electronic display, a processor, and a non-transitory computer-readable medium storing instructions that, when executed by the processor, causes the processor to cause for display on the electronic display a selected representation of vehicle information among a plurality of representations based at least in part on learned behavior of a user.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an example electronic device configured as a mobile phone according to one or more embodiments illustrated and described herein;

FIG. 2 schematically depicts a plurality of example representations of information for the mobile phone illustrated by FIG. 1 according to one or more embodiments illustrated and described herein;

FIG. 3 schematically depicts an example electronic device configured as an electric vehicle according to one or more embodiments illustrated and described herein;

FIG. 4 schematically depicts a plurality of example representations of information for the electric vehicle illustrated by FIG. 1 according to one or more embodiments illustrated and described herein;

FIG. 5 graphically depicts an example method for selecting a representation of information for display on an electronic display according to one or more embodiments illustrated and described herein;

FIG. 6 graphically depicts another example method for selecting a representation of information for display on an electronic display according to one or more embodiments illustrated and described herein; and

FIG. 7 schematically illustrates example components of an example electronic device according to one or more embodiments illustrated and described herein.

### DETAILED DESCRIPTION

Embodiments of the present disclosure are directed to electronic devices and methods for displaying information on electronic displays of electronic devices based on learned user behavior. Information may be displayed by an electronic display of an electronic device in a variety of different representations. For example, a numerical value may be represented as a numeral, a percentage, a graph, an icon, a color representation, and the like. In many cases, the information has a purpose, and thus the information may be presented to a user so that the user satisfies a goal, such as taking certain action based on the information. In a mobile phone battery example, a goal may be that the user charges the mobile phone battery before its state of charge is below a certain point (e.g., 10%).

One representation of the information may cause the user to more readily charge the mobile phone battery before it reaches or goes below 10% state of charge. For example, a first person may more readily charge her mobile phone battery in satisfaction with a goal when a representation of the state of charge of the mobile phone battery is a percentage. A second person may more readily charge her mobile phone battery in satisfaction with the same goal when a representation of the state of charge of the mobile phone battery is a colored icon.

However, in many cases the representations of certain pieces of information are static and either cannot be changed by the user, the user does not know how to change the representation or the user does not know what is the best representation of information for her.

In embodiments of the present disclosure, a best representation of information is automatically selected and displayed based on learned behavior of one or more users. As used herein, “select,” “selected,” and “selected representation” means that the representation is selected automatically by a processor and without user intervention such that the user does not take steps to select a preferred representation of information for display, such as manually setting preferences in a settings menu. As used herein, “learned behavior” of a user means behavior of a user of an electronic device that is learned by monitoring a user's interaction with the electronic device as different representations are displayed by the electronic device.

As described in more detail below, behaviors of a user of an electronic device are learned over time, and representations of information that most likely align with one or more goals are automatically selected and displayed on an electronic device.

Various embodiments of electronic devices and methods for displaying information on electronic displays of electronic devices based on learned user behavior are described below.

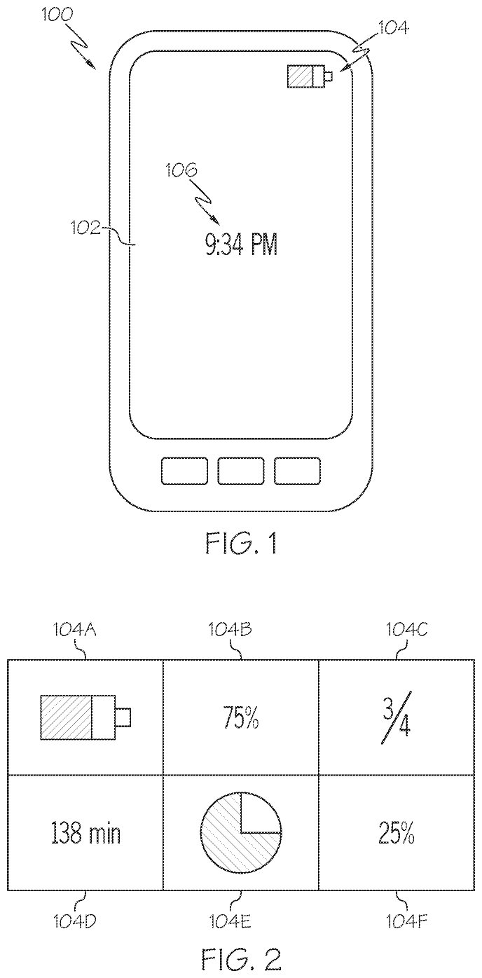

Referring now to FIG. 1, an example electronic device configured as a mobile phone 100 is illustrated. It should be understood that the electronic devices described herein are not limited to mobile phones, and that the electronic devices may be any electronic devices having an electronic display that presents information.

The mobile phone 100 includes an electronic display 102 that presents information to a user. The electronic display 102 may present any type of information. In the illustrated example, the electronic display 102 displays information in the form of a state of charge of a battery of the mobile phone and the current time. A representation 104 of the state of charge is set as an icon configured as a battery in the non-limiting example. A colored portion within the icon is indicative as to how “full” the battery is, i.e., the current percentage of the state of charge. As described in more detail below, there are many more possible representations of the state of charge that may be displayed to the user, and some representations may be better than others at satisfying a goal.

In the illustrated example, a representation 106 of the current time is provided as a 12-hour digital clock representation (9:34 PM). However, there are other possible representations for the current time. For example, the representation may be an analog clock face, a 24-hour digital clock representation, and others.

It should be understood that there are limitless types of information that may have multiple representations (e.g., calendar dates, vehicle data, financial information, measurement information, and the like).

Referring now to FIG. 2, non-limiting examples of different representations of the state of charge of the battery of the mobile phone 100 are illustrated. It should be understood that embodiments are not limited to those representations shown in FIG. 2, and that other representations are possible.

Representation 104A is an icon configured as a battery. A colored portion within the icon is indicative as to the state of charge of the battery of the mobile phone 100. The greater the colored portion, the greater the state of charge of the battery. In some embodiments, the icon may change color, such as red when the state of charge is below a low threshold, yellow when the state of charge is between the low threshold and a high threshold, and green when the state of charge is greater than the high threshold. The icon may also be animated. For example, the icon may flash or move when the state of charge is below a certain threshold so that the user's attention is drawn to the icon.

Representation 104B is a percentage value that is displayed by the user that numerically represents the state of charge of the battery of the mobile phone 100. Some users may react more favorably to the percentage value than to the icon of representation 104A. Representation 104B may also change color and be animated as described above with respect to representation 104A.

Representation 104C is a fraction that represents the current state of charge of the battery of the mobile phone 100. For example, instead of displaying “75%”, representation 104C provides the fraction ¾. Representation 104C may also change color and be animated as described above with respect to representation 104A.

Representation 104D is a numerical value that represents the state of charge of the battery in terms of a predicted remaining time of usage. For example, the mobile phone 100 knows the current state of charge, and may access a history of the user's use of the mobile phone 100 that provides an average energy usage (e.g., based on time of day, typical applications used, frequency of talking on the phone, etc.) to calculate an estimated time remaining. In this manner, the user may have an idea of how much time she may use the mobile phone 100 based on the current state of charge and typical usage patterns. Representation 104D may also change color and be animated as described above with respect to representation 104A.

Representation 104E is a pie-chart graph that depicts the current state of charge of the battery of the mobile phone 100. As the state of charge decreases, the proportion of the colored portion of the pie-chart graph also decreases. Representation 104E may also change color and be animated as described above with respect to representation 104A.

Representation 104F is similar to representation 104B except it shows the percentage value of the amount of charge used rather than an amount of charge remaining. Representation 104F may also change color and be animated as described above with respect to representation 104A.

Thus the information of the state of charge of the battery of a mobile phone 100 may be represented by a plurality of representations. One or more representations of the plurality of representations may best satisfy the goal(s) of a user, as described in more detail below. The plurality of representations may be provided in a database that may be accessed by the processor of the electronic device. The plurality of representations may include instructions regarding how to transform the numerical information into the selected representation, for example.

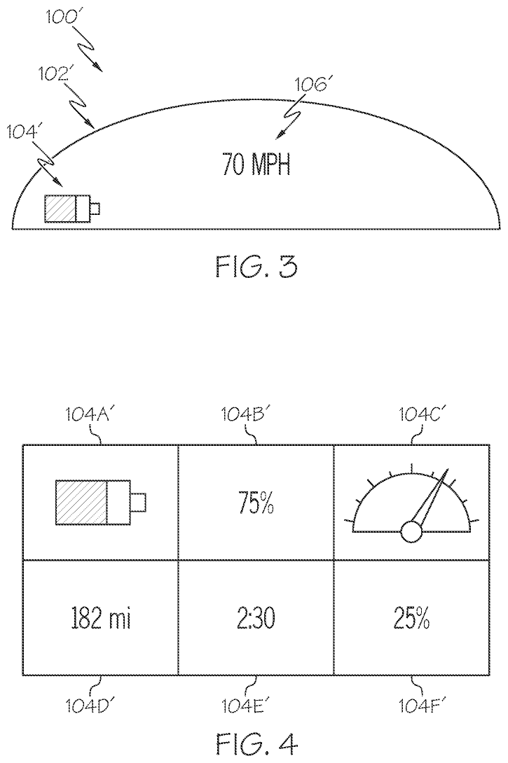

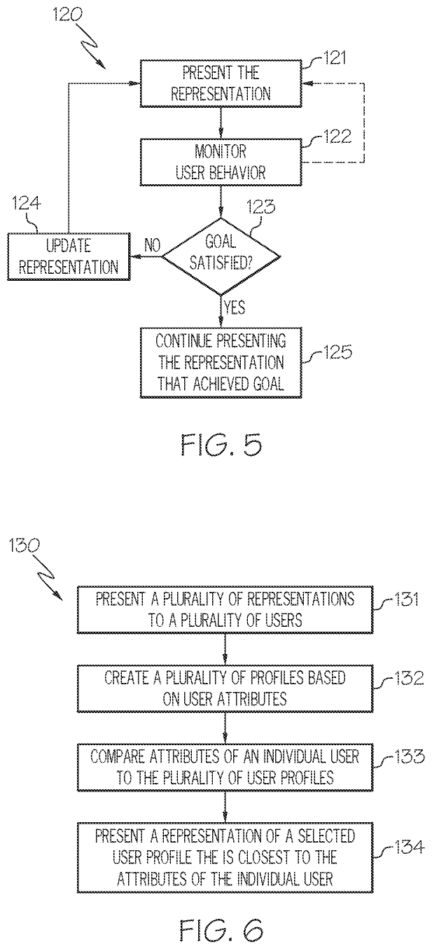

FIG. 3 illustrates another electronic device configured as an electric vehicle 100′ having an electronic display 102′ configured as a cluster display. The electronic display 102′ may display any type of information, such as vehicle information in the form of a representation 104′ showing a state of charge of the vehicle battery and a representation 106′ showing a speed of the electric vehicle 100′. It should be understood that embodiments are not limited to electric vehicles, and may be utilized in internal combustion engine vehicles. Similar to the example of FIG. 2, the representation 106′ showing the speed may come in many different forms. The speed may be a digital display of a numeric value as shown by representation 106′, but the representation could also be display of an analog speedometer gauge, a bar graph, an icon, and the like. The representation 106′ may also change colors and be animated, for example. One or more of the possible representations for the vehicle speed may satisfy a goal the best (i.e., better than the others). In the speedometer context, the goal may be related to driving under the speed limit. The goal may be objectively defined, such as the driver driving at or below the speed limit a certain percentage of time. For example, the representation of the speed that satisfies the goal may be the representation that has the highest percentage of driving time that the driver drove at or below the speed limit among all of the representations for vehicle speed. Additional information regarding determining whether or not a goal is satisfied is provided below with respect to FIG. 5.

FIG. 4 illustrates non-limiting examples of different representations of the state of charge of the battery of the electric vehicle 100′. It should be understood that embodiments are not limited to those representations shown in FIG. 4, and that other representations are possible. The representations of FIG. 4 are similar in some regards to the representations shown in FIG. 2.

Representation 104A′ is an icon configured as a battery. A colored portion within the icon is indicative as to the state of charge of the battery of the electric vehicle 100′. The greater the colored portion, the greater the state of charge of the battery. In some embodiments, the icon may change color, such as red when the state of charge is below a low threshold, yellow when the state of charge is between the low threshold and a high threshold, and green when the state of charge is greater than the high threshold. The icon may also be animated. For example, the icon may flash or move when the state of charge is below a certain threshold so that the user's attention is drawn to the icon.

Representation 104B′ is a percentage value that is displayed by the user that numerically represents the state of charge of the battery of the electric vehicle 100′. Some users may react more favorably to the percentage value than to the icon of representation 104A′. Representation 104B′ may also change color and be animated as described above with respect to representation 104A′.

Representation 104C′ is a display of an analog gauge that represents the current state of charge of the battery of the electric vehicle 100′. Representation 104C′ is similar to a fuel gauge of an internal combustible engine vehicle in this regard. Representation 104C′ may also change color and be animated as described above with respect to representation 104A′.

Representation 104D is a numerical value that represents the state of charge of the battery in terms of a predicted remaining miles until the battery is depleted. For example, the electric vehicle 100′ knows the current state of charge, and may access a history of the user's use of the vehicle 100′, determine elevation changes in the driver's route, note the current temperature, and the like, to calculate an average energy usage, such as a watt-hours per mile to calculate an estimated miles remaining. In this manner, the user may have an idea of how much further she may drive the electric vehicle 100′ based on the current state of charge and predicted energy usage. Representation 104D′ may also change color and be animated as described above with respect to representation 104A′.

Representation 104E′ is a time value in hours and minutes that depicts the remaining amount of time that the driver can operate the electric vehicle 100′ based on the current state of charge and the predicted energy usage based on the factors described above. Using the current state of charge and the predicted watt-hours per mile, an estimated time remaining before depleting the battery is calculated and displayed. Representation 104E′ may also change color and be animated as described above with respect to representation 104A′.

Representation 104F′ is similar to representation 104B′ except it shows the percentage value of the amount of charge used rather than an amount of charge remaining. Representation 104F′ may also change color and be animated as described above with respect to representation 104A′.

No matter the type of information or the types of representations, embodiments of the present disclosure monitor a user's behavior to determine learned behavior that is used to select the best representation of the information for the individual user. As used herein, “best representation” means the representation among a plurality of representations that satisfy a goal objectively better than the remaining representations. In the example of FIG. 4, if representation 104C′ satisfies the goal of the driver charging the electric vehicle 100′ before the state of charge of the battery is 20% more frequently than representations 104A′, 104B′, 104D′, 104E′, and 104F′, then it is selected as the selected representation and displayed by the electronic display 102′.

Referring now to FIG. 5, an example method 120 of determining learned behavior of a user and using the learned behavior to select a representation for display by an electronic display is illustrated. At block 121, an individual representation of information (i.e., a displayed representation) is displayed by the electronic display to the user. The information may be any type of information, such as state of charge of a battery, speed, and time as described above. The individual representation is continued to be presented by the electronic display for some period of time (e.g., a few hours, a few days, a month, etc.).

While the individual presentation is being displayed, the user's behavior is monitored by the electronic device (block 122). In some embodiments, the user's behavior is continuously being monitored, as indicated by the dashed arrow. The user's behavior is based on the user's interactions with the electronic display and/or the electronic device associated with the electronic display. The user's behavior that is monitored may be relevant to a goal of presenting the information. Embodiments are not limited by any behavior, type of interaction, or goal. In the non-limiting example shown by FIG. 2, the goal may be that the user charges her mobile phone 100 before the state of charge reaches 20%. Thus, interactions relevant to the goal would be the state of charge of the battery of the mobile phone 100 when the user plugs it in to charge, the frequency of plugging the mobile phone 100 in to charge, a duration of charge, and the like. These types of interactions may be monitored, logged and stored in a database, for example.

A metric relating to the goal may be used to determine how well the displayed representation satisfies the particular goal. Any metric may be used. For example, a metric may be a percentage of times that an event occurs or does not occur. In the mobile phone example, the metric may be the percentage of time that the user charges the battery when the battery is over 20%.

After a period of time, the process moves to block 123 where it is determined whether or not the goal has been satisfied by the previously displayed representation. As a non-limiting example, the goal may be satisfied when the user exceeds the predetermined metric by a threshold amount. As a non-limiting example, the metric may be a percentage that the user charges the battery before it reaches 20% state of charge and the threshold may be 80% of the time. If the percentage is less than 80%, the goal is not satisfied and the process moves to block 124. If the percentage is greater than or equal to 80% then the process moves to block 125. At block 125 the electronic device persistently displays the representation that satisfied the goal at block 123. For example, if the representation is a percentage value of a state of charge, and the user charges the battery before the battery reaches 20% state of charge 95% of the time, the percentage representation will be used to display state of charge information going forward.

In some embodiments, the user's behavior is continued to be monitored and learned such that if the goal is not satisfied in the future, the process will go from block 125 to block 124 such that a new representation is evaluated.

At block 124, the representation is updated to a new representation that has not yet been evaluated. As a non-limiting example, if the representation that failed to satisfy the goal at block 123 is an icon, the updated representation at block 124 may be a percentage value. The process then moves back to block 121 and repeats to evaluate the updated representation. If the updated representation satisfies the goal at block 123, it is persistently displayed at block 125. If the updated representation does not satisfy the goal at block 123, the representation is updated again with a new representation at block 124.

In some embodiments, if none of the representations satisfy the goal at block 123, a best-performing representation of information is selected. In the mobile phone battery example, the best-performing representation of information may be the representation having the highest percentage of charges when the state of charge of the battery is greater than 20%, even though the percentage may be below the threshold metric, such as 80%.

Variations of the process depicted by FIG. 5 are encompassed by embodiments of the present disclosure, and thus embodiments are not limited by the steps and the order of steps depicted by FIG. 5. In one variation, each representation of the plurality of representations is individually evaluated over increments of time. For example, a first representation is evaluated for learned behavior over a first period of time, then a second representation is evaluated for learned behavior over a second period of time, and the like until all representations of the plurality of representations are evaluated. In a non-limiting example, the representation that satisfies the goal is the representation having the best performance with respect to the metric. In the mobile phone battery example, the representation having the highest percentage of time that the user charges the phone when the state of charge is greater than 20% may be selected as satisfying the goal and therefore selected for display by the electronic display.

FIG. 6 illustrates another example method 130 of selecting a representation among a plurality of representations of information for display on an electronic display based on learned user behavior. The method 130 of FIG. 6 operates by evaluating many different users in a crowdsourcing manner. Generally, attributes of many users are learned to develop individual user profiles based on the attributes. Each user profile has a preferred representation associated therewith. An individual user is monitored to determined learned behavior of the user. The user is assigned a user profile based on her learned behavior. The representation of the information associated with the assigned user profile is selected for display by the electronic display.

At block 131, a plurality of representations of information are presented to a plurality of users. The plurality of users may include thousands of users, for example. As a non-limiting example, for each user, each representation of information of a plurality of representations are displayed for a period of time. For example, each user of a mobile phone 100 may view representations 104A-104F shown in FIG. 2 over periods of time.

At block 132, a plurality of user profiles are created based on user attributes while the plurality of users interact with their electronic devices. The attributes are thus based on interactions with electronic devices. The interactions that are monitored are not limited to those that are directly relevant to the goal. Using the mobile phone battery charging example, when and how often a user charges her phone are interactions that are evaluated to determine user attributes. However, other interactions not directly related to battery charging are also logged. Interactions such as frequency of mobile phone use, times of day of mobile phone use, types of applications utilized, purchases made by using the mobile phone, the brand and model of the mobile phone, etc. may be used as attributes. The interactions are indicative of a user's personality, which may be further indicative of a preferred representation of information among a plurality of representations. It should be noted that the logging of user interactions and the monitoring of user behavior may be performed anonymously and without personally identifiable information. In some embodiments, the learning of user behavior is done completely locally on the electronic device and the user behavior is not shared with third parties.

For each user, interactions with the electronic device are logged and the presently displayed representation is also noted. The interactions and the displayed representations for the plurality of users are then utilized to form the user profiles. In some embodiments, a machine learning algorithm is used to develop the user profiles. The interactions and the displayed representations for the plurality of users are provided as inputs to a machine learning algorithm, such as a clustering algorithm, that then creates clusters or groups. Each cluster may be a user profile. Any known or yet-to-be-developed clustering algorithm or other machine learning algorithm capable of receiving the interactions and representations and creating individual user profiles (i.e., clusters) may be utilized.

Ideally, each user will have similar user traits. Using the mobile phone example, it may be that a user that uses the mobile phone late at night uses the mobile phone for many hours, and frequently lets the battery drain. Each user profile may have a representation of information that performs best according to the stated goal. The best-performing representation is assigned as the selected representation for that user profile.

At block 133, an individual user's attributes are monitored over time. These attributes may be the same interactions that were used to develop the plurality of user profiles. The individual user's attributes are compared with those of the plurality of user profiles. The user profile having attributes that most closely match the attributes of the individual user is assigned to the individual user. As a non-limiting example, the interactions and displayed representations of the individual user are provided as input into the machine learning algorithm or model used to develop the plurality of user profiles. The machine learning algorithm or model assigns the user to the closest user profile (i.e., the closest cluster).

At block 134, the electronic device displays a selected representation of information that is associated with the assigned user profile of the user. Thus, the system displays the best representation of information for the user based on evaluations of many other users. Users having similar traits are shown the same representations of information. For example, users having attributes A, B, and C are similar and assigned a first user profile that get shown representation 104A of FIG. 2. On the other hand, users having attributes X, Y and Z are similar and assigned a second user profile that get shown representation 104D of FIG. 2. In this manner, users get shown an ideal representation based on their personalities.

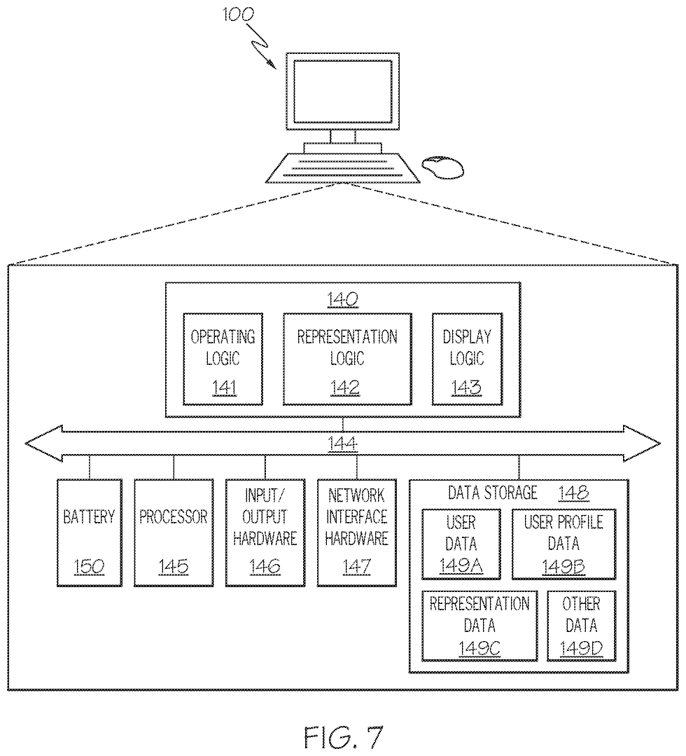

Embodiments of the present disclosure may be implemented by any type of electronic device, and may be embodied as computer-readable instructions stored on a non-transitory memory device. FIG. 7 depicts an example electronic device 100 (e.g., a computer) configured to perform the functionalities described herein. The example electronic device 100 provides a system for displaying information on an electronic display based on learned user behavior, and/or a non-transitory computer usable medium having computer readable program code for displaying information on an electronic display based on learned user behavior embodied as hardware, software, and/or firmware, according to embodiments shown and described herein. While in some embodiments, the electronic device 100 may be configured as a general purpose computer with the requisite hardware, software, and/or firmware, in some embodiments, the electronic device 100 may be configured as a mobile phone, a vehicle, an electric appliance, and the like. It should be understood that the software, hardware, and/or firmware components depicted in FIG. 7 may also be provided in other computing devices external to the electronic device 100 (e.g., data storage devices, remote server computing devices, and the like).

As also illustrated in FIG. 7, the electronic device 100 (or other additional computing devices) may include a battery 150 for powering the electronic device 100, a processor 145, input/output hardware 146, network interface hardware 147, a data storage component 148 (which may include user data 149A, user profile data 149B, representation data 149C, and any other data 149D for performing the functionalities described herein), and a non-transitory memory component 140. The memory component 140 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 140 may be configured to store operating logic 141, representation logic 142 for selecting a representation of information for display, and display logic 143 for displaying the representation of information on an electronic display (each of which may be embodied as computer readable program code, firmware, or hardware, as an example). A local interface 144 is also included in FIG. 7 and may be implemented as a bus or other interface to facilitate communication among the components of the electronic device 100.

The processor 145 may include any processing component configured to receive and execute computer readable code instructions (such as from the data storage component 148 and/or memory component 140). The input/output hardware 146 may include an electronic display, keyboard, mouse, printer, camera, microphone, speaker, touch-screen, and/or other device for receiving, sending, and/or presenting data. The network interface hardware 147 may include any wired or wireless networking hardware, such as a modem, LAN port, wireless fidelity (Wi-Fi) card, WiMax card, mobile communications hardware, and/or other hardware for communicating with other networks and/or devices, such as to receive the data from various sources, for example.

It should be understood that the data storage component 148 may reside local to and/or remote from the electronic device 100, and may be configured to store one or more pieces of data for access by the electronic device 100 and/or other components. As illustrated in FIG. 7, the data storage component 148 may include user data 149A, which in at least one embodiment includes data with respect to the user, such as user attributes, user behavior, and the like. The user data 149A may be stored in one or more data storage devices. Similarly, user profile data 149B may be stored by the data storage component 148 and may include information relating to user profiles as described above if such user profiles are utilized to select the representations of information. Representation data 149C includes data relating to the various types of graphical representations used to possible represent information displayed to the user. For example, representation data 149C may include information regarding how to display the representation (e.g., the look of an icon or the type of font). Other data 149D to perform the functionalities described herein may also be stored in the data storage component 148. In some embodiments, the electronic device 100 may be coupled to a remote server or other data storage device that stores the relevant data.

Included in the memory component 140 may be the operating logic 141, the representation logic 142, and the display logic 143. The operating logic 141 may include an operating system and/or other software for managing components of the electronic device 100. The operating logic 141 may also include computer readable program code for displaying the graphical user interface used by the user to input parameters and review results of the simulations. The representation logic 142 may reside in the memory component 140 and may be configured to facilitate the functionalities described herein, such as learning user behavior, determining whether a goal is satisfied, and selecting a representation for display among a plurality of representations. The representation logic 142 may also be configured to compare attributes of an individual user to assign a user profile and representation to the user.

The components illustrated in FIG. 7 are merely exemplary and are not intended to limit the scope of this disclosure. More specifically, while the components in FIG. 7 are illustrated as residing within the electronic device 100, this is a non-limiting example. In some embodiments, one or more of the components may reside external to the electronic device 100.

It should now be understood that embodiments of the present disclosure are directed to electronic devices and methods for displaying information on electronic displays of electronic devices based on learned user behavior. A representation of information that is best suited for the user is selected and displayed based on the learned user behavior. The best suited representation is a representation among a plurality of representations that satisfies a goal or is an objectively best performing representation. Embodiments enable a user interface to be automatically customized for an individual user so that the user attains certain goals without requiring the user to manually program settings.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. An electronic device comprising:
an electronic display;
a processor; and
a non-transitory computer-readable medium storing instructions that, when executed by the processor, causes the processor to cause for display on the electronic display a selected representation of information among a plurality of representations of the information based at least in part on learned behavior of a user.

2. The electronic device of claim 1, wherein the plurality of representations comprise two or more of a percentage, a fraction, an icon, a graph, and a numeral.

3. The electronic device of claim 1, wherein:
the plurality of representations are stored in a database; and
the instructions further cause the processor to transform the information into the selected representation for display on the electronic display.

4. The electronic device of claim 1, wherein the instructions, when executed by the processor, cause the processor to determine the learned behavior by:
changing a displayed representation of the information that is displayed on the electronic display over time, wherein the displayed representation is an individual representation of the plurality of representations; and
monitoring interactions with the electronic device by a user for each displayed representation of the information to determine the learned behavior.

5. The electronic device of claim 4, wherein the instructions, when executed by the processor, further cause the processor to:
determine whether one or more interactions of the learned behavior satisfy a goal when each displayed representation of the information is displayed; and
select an individual displayed representation as the selected representation when the individual displayed representation satisfies the goal.

6. The electronic device of claim 5, wherein the selected representation causes satisfaction of the goal at a highest frequency among remaining displayed representations of the plurality of representations.

7. The electronic device of claim 1, wherein the instructions, when executed by the processor, cause the processor to determine the learned behavior by determining attributes of the user by monitoring interactions of the user with the electronic device.

8. The electronic device of claim 7, wherein the selected representation is determined by:
comparing the attributes of the user with a plurality of user profiles, wherein the plurality of user profiles is based on attributes determined from interactions of a plurality of users with a plurality of electronic devices, and each user profile is associated with a preferred representation of the information;
selecting a selected user profile among the plurality of user profiles, wherein the selected user profile has attributes closest to the attributes of the user; and
the preferred representation of the information of the selected user profile is selected as the selected representation of the information.

9. The electronic device of claim 1, wherein the electronic device is a mobile phone.

10. The electronic device of claim 1, wherein the electronic device is a vehicle.

11. A method comprising displaying on an electronic display a representation of information selected among a plurality of representations of the information based on learned behavior of a user.

12. The method of claim 11, wherein the plurality of representations comprise two or more of a percentage, a fraction, an icon, a graph, and a numeral.

13. The method of claim 11, wherein:
the plurality of representations are stored in a database; and
the method further includes transforming the information into the selected representation.

14. The method of claim 11, wherein the learned behavior is determined by:
changing a displayed representation of the information that is displayed by the electronic display over time, wherein the displayed representation is an individual representation of the plurality of representations; and
monitoring interactions with an electronic device including the electronic display by a user for each displayed representation of the information to determine the learned behavior.

15. The method of claim 14, further comprising:
determining whether one or more interactions of the learned behavior satisfy a goal when each displayed representation of the information is displayed; and
selecting an individual displayed representation as the selected representation when the individual displayed representation satisfies the goal.

16. The method of claim 15, wherein the selected representation causes satisfaction of the goal at a highest frequency among remaining displayed representations of the plurality of representations.

17. The method of claim 11, wherein the learned behavior is determined by determining attributes of the user by monitoring interactions of the user with an electronic device including the electronic display.

18. The method of claim 17, wherein the selected representation is determined by:
comparing the attributes of the user with a plurality of user profiles, wherein the plurality of user profiles is based on attributes determined from interactions of a plurality of users with a plurality of electronic devices, and each user profile is associated with a preferred representation of the information;
selecting a selected user profile among the plurality of user profiles, wherein the selected user profile has attributes closest to the attributes of the user; and
the preferred representation of the information of the selected user profile is selected as the selected representation of the information.

19. A vehicle comprising:
an electronic display;
a processor;
a non-transitory computer-readable medium storing instructions that, when executed by the processor, causes the processor to cause for display on the electronic display a selected representation of vehicle information among a plurality of representations of the information based at least in part on learned behavior of a user.

20. The vehicle of claim 19, wherein:
the vehicle comprises a battery;
the vehicle information is a state of charge of the battery; and
the plurality of representations comprises two or more of: a battery icon, a percentage, a graph.
